(19) United States
(12) Patent Application Publication
(10) Pub. No.: US 2026/0212104 A1
(43) Pub. Date: Jul. 23, 2026

(54) FPGA-ORIENTED DSP PLACEMENT OPTIMIZATION METHOD FOR CNN ACCELERATORS

(71) Applicant: THE CHINESE UNIVERSITY OF HONG KONG, SHENZHEN, Shenzhen (CN)

(72) Inventors: Tinghuan CHEN, Shenzhen (CN); Baohui XIE, Shenzhen (CN); Xinrui ZHU, Shenzhen (CN)

(73) Assignee: THE CHINESE UNIVERSITY OF HONG KONG, SHENZHEN, Shenzhen (CN)

(21) Appl. No.: 19/330,885

(22) Filed: Sep. 17, 2025

(30) Foreign Application Priority Data
Jan. 22, 2025 (CN) 202510096790.6

(51) Int. Cl. G06F 30/398; G06F 17/11; G06F 30/392; G06F 111/04; G06F 111/10; G06F 115/10

(52) U.S. Cl. CPC G06F 30/398; G06F 17/11; G06F 30/392; G06F 2111/04; G06F 2111/10; G06F 2115/10

(57) ABSTRACT

An FPGA-oriented DSP placement optimization method for CNN accelerators includes the following steps: S1. DSP path information extraction: converting a designed netlist into a graph representation, and carrying out data-path DSP node identification and data-path DSP graph building; and S2. datapath-driven DSP placement: distributing data-path DSP nodes to specific positions on an FPGA according to an extracted data-path DSP graph. According to the invention, automated extraction and building of data-path DSP graphs are carried out by means of graph neural network (GCN)-based DSP node classification and min-cost flow (MCF) model optimization algorithms, and compact placement and cascade constraint optimization are used in combination, thereby greatly improving the timing performance and computing efficiency of the placement and also significantly improving the clock frequency and throughput. Therefore, the method provides a universal and efficient FPGA placement solution for multiple CNN accelerator architectures.

### CROSS REFERENCE TO THE RELATED APPLICATIONS

This application is based upon and claims priority to Chinese Patent Application No. 202510096790.6, filed on Jan. 22, 2025, the entire contents of which are incorporated herein by reference.

### TECHNICAL FIELD

The present invention relates to the fields of integrated circuit design and hardware accelerator optimization, in particular to an FPGA-oriented DSP placement optimization method for CNN accelerators.

### BACKGROUND

In recent years, convolutional neural networks (CNNs) have been widely used in fields such as image recognition and target detection due to their excellent performance in computer vision tasks. As a highly flexible hardware platform, Field Programmable Gate Array (FPGA) is an ideal choice for deploying CNN due to its reconfigurable nature and parallel computing capabilities. However, the placement stage in the design process of FPGA has a significant impact on final performance, and existing technologies still face many challenges in optimizing placement.

In FPGA design, the placement problem is a complex combination optimization problem. It is required to map heterogeneous components (such as lookup tables (LUT), flip flops (FF), digital signal processing units (DSP) to fixed positions on an FPGA chip. The placement results directly affect the wire length and timing performance. However, due to the heterogeneity of resource distribution in an FPGA (for example, DSPs and random access memories (RAMs) are distributed in units of columns) and the requirements for wide bit width and high parallelism in modern CNN accelerators, it is difficult to effectively solve these problems using conventional placement methods.

Existing placement algorithms are mainly divided into two categories: simulated annealing method and analytical method. The simulated annealing method can achieve high-quality placement in small-scale designs. However, as the design scale increases, the simulated annealing method cannot meet the needs of large-scale CNN accelerators because its runtime increases exponentially. Although the analytical method improves the scalability and efficiency of the placement by means of mathematical models, the analytical method usually ignores the structural information of the datapath, resulting in wiring detours, which in turn affects timing performance. In addition, the lack of datapath information is one of the main shortcomings in the prior art. The datapath consists of digital signal processing units (DSP) responsible for computations, the placement of which determines the criticality of a timing path. However, many existing methods only focus on the spatial distribution of components and fail to integrate datapath information into the placement process, which leads to increased wiring complexity and reduced performance. Even though some studies attempt to introduce datapath rules, such as graph clustering-based DSP grouping or empirical rules for DSP allocation, most of these methods have difficulty in adapting to different FPGA architectures and CNN designs due to lack of generality and automation capabilities.

### SUMMARY

The objective of the present invention is to overcome the defects of the prior art and provide an FPGA-oriented DSP placement optimization method for CNN accelerators. According to the present invention, automated extraction and building of datapath DSP graphs are carried out by means of graph neural network (GCN)-based DSP node classification and minimum cost flow (MCF) model optimization algorithms, and the combination of compact placement and cascade constraint optimization greatly improves the timing performance and computing efficiency of the placement, while significantly improving the clock frequency and throughput, providing a universal and efficient FPGA placement solution for multiple CNN accelerator architectures.

The objective of the present invention is achieved by the following technical solutions: An FPGA-oriented DSP placement optimization method for CNN accelerators includes the following steps:
S1. DSP path information extraction: converting a design netlist into a graph representation, and carrying out datapath DSP node identification and datapath DSP graph building; and
S2. datapath-driven DSP placement: allocating the datapath DSP nodes to specific positions on the FPGA according to the extracted datapath DSP graph.

The beneficial effects of the present invention are as follows: According to the present invention, automated extraction and building of datapath DSP graphs are carried out by means of graph neural network (GCN)-based DSP node classification and min-cost flow (MCF) model optimization algorithms, and compact placement and cascade constraint optimization are used in combination, thereby greatly improves the timing performance and computing efficiency of the placement and also significantly improving the clock frequency and throughput. Therefore, the present invention provides a universal and efficient FPGA placement solution for multiple CNN accelerator architectures.

### BRIEF DESCRIPTION OF THE DRAWINGS

FIG. 1 is a flow chart of a method according to the present invention.

FIG. 2 is a schematic diagram of legalization of datapath digital signal processing units.

FIG. 3 is a schematic diagram of incremental datapath DSP placement.

FIGS. 4A and 4B are pie charts for runtime analysis of the present invention

### DETAILED DESCRIPTION OF THE EMBODIMENTS

The technical solution of the invention is described in further detail below in conjunction with the accompanying drawings, but the scope of protection of the invention is not limited to the following description.

According to the present invention, a design netlist of a CNN accelerator is used as an input; then, the placement of all components is initialized using an existing FPGA placement tool to generate an initial placement solution, where an initial position is an initial solution calculated by the existing placement tool; and then the placement is iteratively optimized until the results converge; and finally an optimized placement result is output. In each iteration, firstly, the placement about DSP in the current placement is discarded, and the placement of non-DSP components is retained; and then a datapath-driven DSP placement module is used to optimize the positions of the DSP and non-DSP components in sequence. This process involves fine-grained placement of DSP macros to ensure rationality of placement and performance of the circuit; specifically:

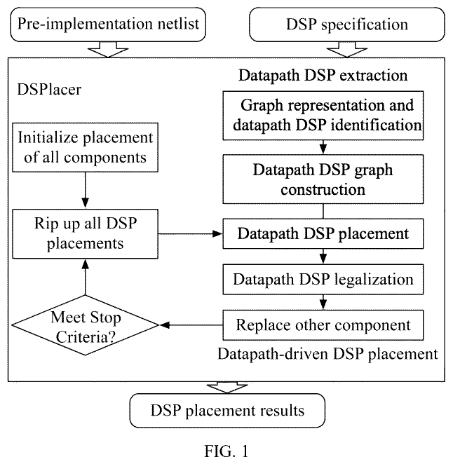

As shown in FIG. 1, an FPGA-oriented DSP placement optimization method for CNN accelerators includes the following steps:

S1. DSP path information extraction: converting a design netlist into a graph representation, and carrying out datapath DSP node identification and datapath DSP graph building;

Step S1 includes:
S101. graph representation and datapath DSP node identification: converting a design netlist into a directed graph, and classifying datapath DSP nodes and control-path DSP nodes, thereby realizing datapath DSP node identification.

Step S101 includes:
A1. giving a design netlist which comprises logic components and connection relationships between the logic components;
A2. converting the design netlist into a directed graph G=(V, E), where nodes in a node set V represent logic components in the design netlist, edges in an edge set E represent connection relationships between the logic components, and the logic components include DSPs, LUTs and RAMs;
A3. extracting features of each node from the design netlist, including local features and global features, where the local features include an in-degree and an out-degree and the global features include proximity centrality, betweenness centrality, eccentricity, and the number of feedback loops;
for any node v in the node set V, the in-degree, out-degree, between-centrality, near-centrality, eccentricity, and number of feedback loops are defined as follows:
the in-degree of node v refers to the number of nodes connected to an input terminal of node v;
the out-degree of node v refers to the number of nodes connected to an output terminal of node v;
betweenness centrality measures the importance of a node as an intermediary for the shortest path between other nodes, and the betweenness centrality of node v is defined as follows:

$${C}_{B} ( v ) = {\sum }_{{u}_{i} , {u}_{l} ▯ V} \frac{σ ( {u}_{i} , {u}_{l} ) \vert v}{σ ( {u}_{i} , {u}_{l} )}$$

where σ(uᵢ,uₗ) represents the number of shortest paths between nodes uᵢ and uₗ, σ(uᵢ,uₗ)/vrepresents the number of paths passing through node v among these paths, and C_{B}(v) represents the betweenness centrality of node v;
proximity centrality is used to measure the reciprocal of an averaged distance between a node and other nodes, and the proximity centrality of node v is defined as follows:

$${C}_{C} ( v ) = \frac{1}{{Σ}_{u ▯ V , u \neq u} d ( v , u )}$$

where d (v, u) represents a shortest path distance between node v and node u, and C_{C}(v) represents the proximity of node v;
eccentricity measures a distance between a node and the other node farthest away, and the eccentricity of node v is defined as follows:

$$ecc ( v ) = {}_{u ∈ V}^{ma x} d ( v , u )$$

where d (v, u) represents a shortest path distance between node v and node u, and ecc(v) represents the eccentricity of node v;
the number of feedback loops at node v refers to the number of paths starting from node v and returning to node v;
A4. modeling a DSP identification problem as a binary classification problem, and labeling some DSP nodes in the node set V: labeling the datapath DSP nodes as one category, and labeling the control-path DSP nodes as another category;
A5. building a graph neural network model, the graph neural network model including: a graph convolutional neural network (GCN), a ReLU activation function, a dropout layer, a graph convolutional neural network (GCN), a ReLU activation function, a dropout layer, a fully connected layer and a Softmax classifier that are connected in sequence; and
A6. training the graph neural network model using the features of the labeled nodes, and classifying unlabeled DSP nodes in the node set V by the trained and mature graph neural network model.

In an embodiment of the present application, the architecture of the model consists of two GCN layers, each layer followed by a ReLU activation function and a dropout layer to prevent overfitting. During training, the model optimizes parameters by minimizing a cross-entropy loss function. By means of the trained model, the DSP nodes in the design can be classified and the datapath DSP can be accurately distinguished from the control-path DSP. The classified data will be used in subsequent placement optimization processes to ensure that the placement of DSP macros on the FPGA meets both the data flow requirements and the control logic requirements. Such an approach not only improves placement automation, but also enhances the performance and efficiency of the final hardware implementation. In an embodiment of the present application, in order to enhance classification performance, a weighted loss function is used in the present invention to give higher penalty weights to a few categories of nodes. In addition, the accuracy of the model is evaluated by means of cross-validation to ensure the applicability of the model to different design benchmarks.

During the training process, the input of the graph neural network model is the features of a labeled node, and the expected output is the labeled category of the node; after the training is completed, the node features of unlabeled nodes are input into the graph neural network model to complete classification.

Using a graph neural network (GCN) for classification, this method can effectively classify DSPs and guide the subsequent DSP graph building process. By this modeling for a binary classification problem, the present invention can accurately distinguish which DSP nodes belong to the datapath and which belong to the control path when implementing CNN accelerators on an FPGA. This distinction is crucial for subsequent placement optimization because it directly affects the compactness of the data flow. Thanks to the powerful feature extraction capability of the graph neural network, the present invention can learn the hierarchical representations of nodes and integrate the hierarchical representations into a placement optimization framework in an end-to-end manner, thereby realizing a more efficient and accurate DSP macro placement.

S102. After completing the DSP classification, only retaining the identified datapath DSP nodes, and building a datapath DSP graph based on the identified datapath DSP nodes.

Step S102 includes:
shortest path calculation: starting from each datapath DSP node, calculating the shortest path to other datapath DSP nodes using an iterative deepening depth-first search algorithm; and
based on the shortest path information, building a subgraph that only contains datapath DSP nodes and connection relationships thereof. The graph describes the topology between datapath DSP nodes.

With regard to exclusion of control-path DSP nodes, when building a datapath DSP graph, the present invention further removes control-path DSP nodes to avoid the negative impact of the control-path DSP nodes on placement compactness. Specifically, a control path is typically associated with more storage elements (such as flip flops, RAMs), which facilitates signal retention and allows greater placement flexibility and less compactness, while a datapath associated with relatively few storage elements has a higher requirement on compact arrangement to improve performance. Therefore, only datapath DSP nodes related to computations remain in the datapath DSP graph. By the implementation of the datapath DSP extraction stage, the present invention ensures the integrity and accuracy of datapath information in the placement optimization process, thereby providing a guarantee for the final improvement of timing performance.

S2. datapath driven DSP placement: allocating datapath DSP nodes to specific positions on an FPGA according to the extracted datapath DSP graph.

Datapath-driven DSP placement, as an important step in placement optimization, aims to allocate DSP nodes related to the datapath to specific positions on an FPGA according to the extracted datapath DSP graph, while satisfying cascade constraints on the datapath and optimizing the overall placement.

Datapath DSP placement is a complex allocation problem that requires optimizing the allocations of datapath DSP nodes while meeting constraints. To this end, the present invention formalizes the problem into an integer linear programming (ILP) problem to improve placement quality by optimizing distance and path characteristics. However, the computational complexity of directly solving ILP is high, and then the ILP problem is transformed into a min-cost flow (MCF) problem by means of linearization technology, thereby greatly reducing the computational complexity of the optimization problem.

Step S2 includes:

In order to solve the problem of realizing a datapath-driven DSP placement, the DSP placement problem separates the placement of control-path DSP from the placement of datapath DSP, where the placement of control-path DSP is optimized by a commercial tool and the algorithm of the present invention, the datapath DSP placement problem is formalized as a constrained optimization problem with the goal of maximizing timing performance while satisfying all design rules and placement constraints. The following is a detailed description of modeling the datapath DSP placement problem:

S201. transforming a datapath DSP node placement problem into a constrained optimization problem and modeling the datapath DSP placement problem:
setting that the datapath DSP graph includes N datapath DSP nodes to be placed, mapping each datapath DSP node vᵢ, i∈{1,2 . . . ,N} to one of M DSP positions in the FPGA;
setting the coordinates of DSP position j as (P_{x,j},P_{y,j}), j∈{1,2 . . . ,M};
introducing a binary decision variable xi, where j represents an allocation relationship:

$${x}_{i , j} = \{ \begin{matrix}1 , if datapath DSP node i is assigned to DSP position j \\ 0 , datapath DSP node i is not assigned to DSP position j\end{matrix}$$

giving basic hard constraints that must be met by the datapath DSP node placement:
single position constraint: each datapath DSP node must be assigned to one position;
position uniqueness constraint: each position can only be allocated with at most one datapath DSP node;
S202. introducing cascade constraints for the datapath DSP nodes so that the datapath DSP nodes can be arranged in cascade form in the placement, in order to maintain the compactness and directionality of a data link:
datapath DSP nodes cascaded on the DSP graph must be arranged in adjacent positions in the same column;
a cascading relationship between multiple datapath DSP nodes is decomposed into cascading relationships between multiple DSP pairs; the cascading relationship between DSP nodes in each pair is a cascade pair; let C be a set of all cascade pairs, each cascade pair in the set C is denoted as (cₚ, cₛ), cₚ and cₛ represent predecessor and successor nodes respectively, the following constraint needs to be satisfied: cₚ and cₛ are adjacent in placement to ensure continuity and efficiency of signaling. That is, the following constraint needs to be satisfied:

$${x}_{cp , j} = {x}_{cs , j + 1} , ∀ ( {c}_{p} , {c}_{s} ) ∈ C$$

where x_{cp,j} represents a binary decision variable of predecessor cₚ at DSP position j, and x_{cs,j+1} represents a binary decision variable of successor cₛ at DSP position j+1;
S203. in this part of constraints, we also used the previously transformed datapath DSP graph. In an FPGA, the datapaths are made up of DSPs, which directly participate in computations and determine the critical timing paths of the design. Therefore, in DSP placement, cascade constraints need to be met, and further optimization is also required for the characteristics of the datapaths to improve placement compactness and timing performance. Cascade constraints ensure that inter-related DSP nodes in the datapath are closely arranged in physical placement, reducing signaling delay. The overall placement of the datapath DSP aims to reduce the wire length of the DSP nodes by shortening the path to the minimum, and maintain path directionality, reduce detours in signaling and avoid unnecessary path bends. Here, we incorporate cascade constraints and datapath constraints into the overall optimization goal and transform the constraints into soft constraints, thereby building an overall mathematical model in a unified manner as follows. The model combines the directionality and placement compactness of datapaths and is expressed as follows:

$${min}_{{x}_{i , j}} {\sum }_{e ▯ε} {( {x}_{{e}_{p}} - {x}_{{e}_{s}} )}^{T} ( {p}_{x} {p}_{x}^{T} + {p}_{y} {p}_{y}^{T} ) ( {x}_{{e}_{p}} - {x}_{{e}_{s}} ) + λ {\sum }_{{e}_{D} {▯ε}_{D}} ( cos {θ}_{{e}_{D p}} - cos {θ}_{{e}_{D s}} ) + η {\sum }_{( {c}_{p} , {c}_{s} ) ▯ C} {\sum }_{j = 1}^{M - 1} {( {x}_{{c}_{p} , j} - {x}_{{c}_{s} , j + 1} )}^{2} , \qquad ( 1 )$$

$$s . t . {\sum }_{j = 1}^{M} {x}_{i , j} = 1 , {\sum }_{i = 1}^{N} {x}_{i , j} \leq 1 , {x}_{i , j} ∈ \{ 0 , 1 \} ;$$

where ε represents an edge set of any datapath DSP nodes and other component nodes respectively connected to the datapath DSP nodes in the directed graph after netlist conversion, e is an edge in ε, and ε_{D} represents an edge set in the datapath DSP graph, and ep is an edge in ε_{D};
eₚ and eₛ represent the predecessor node and successor node of edge e respectively, xₑ_{ₚ} and xₑ_{ₛ} represent assignment variables of the predecessor node and successor node respectively and are both vectors of length S; S represents the number of placement positions of all components on the FPGA; if eₚ is assigned to position p, then in xₑ_{ₚ}, element p is 1 and the remaining elements are 0; if es is assigned to position q, then in xₑ_{ₛ} the element p is 1 and the remaining elements are 0, where p=1, 2, . . . , S; q=1, 2, . . . , S, and p is not equal to q;
pₓ is a vector composed of the x coordinates of the placement positions of all components on the FPGA; p_{y} is a vector composed of the y coordinates of the placement positions of all components on the FPGA; since the number of placement positions is S, the lengths of pₓ and p_{y} are both S; the superscript T represents transposition, and

$$( {p}_{x} {p}_{x}^{T} + {p}_{y} {p}_{y}^{T} )$$

constitutes a distance matrix;
xₑ_{ₚ}-xₑ_{ₛ} represents a difference vector between vectors xₑ_{ₚ} and xₑ_{ₛ}. In the difference vector, one element is 1, one element is −1, and other elements are 0. The positions of element “1” and element “−1” represent the positions of the predecessor and successor nodes;

θₑ_{_{Dp}} represents an angle between a line from the predecessor node e_{Dp} of edge e_{D} to an ARM core in the FPGA and a horizontal line; θₑ_{_{Ds}} represents an angle between a line from the successor node e_{Ds} of edge e_{D} to the ARM core in the FPGA and the horizontal line; the ARM core is located in the lower left corner of the FPGA by default; λ is a super parameter used to control a trade-off between a distance and a datapath, and η is a penalty factor;
hard constraints directly limit the legitimacy of placement variable x_{i,j} to ensure that the resource allocation of DSP nodes on the FPGA meets basic rules:
single position constraint: each datapath DSP node i must and can only be assigned to one position j; that is:

$${\sum }_{j = 1}^{M} {x}_{i , j} = 1 , ∀ i ∈ \{ 1 , 2 , … , N \}$$

this constraint ensures that each datapath DSP node does not occupy multiple positions repeatedly;
resource restriction constraint: each position j can only accommodate at most one datapath DSP node; the resource restriction constraint is expressed as:

$${\sum }_{i = 1}^{N} {x}_{i , j} \leq 1 , ∀ j ∈ \{ 1 , 2 , … , M \}$$

this constraint ensures reasonable use of limited resources on the FPGA and avoids resource conflicts;
variable legitimacy constraint: x_{i,j} is a binary variable, indicating whether a datapath DSP node i is assigned to a position j; that is:

$${x}_{i , j} ∈ \{ 0 , 1 \} , ∀ i ∈ \{ 1 , 2 , … , N \} , ∀ j ∈ \{ 1 , 2 , … , M \}$$

S204. three penalty terms in an objective function together constituting soft constraints; these constraints achieve flexible placement adjustments based on weight parameters of the optimization process:
distance constraint for a datapath DSP node and other components connected to the node:

$${\sum }_{e ▯ε} {( {x}_{{e}_{p}} - {x}_{{e}_{s}} )}^{T} ( {p}_{x} {p}_{x}^{T} + {p}_{y} {p}_{y}^{T} ) ( {x}_{{e}_{p}} - {x}_{{e}_{s}} )$$

this term represents the sum of the squares of distances between a DSP node in a path and other component nodes connected to the node, with an optimization goal being to minimize the length of the datapath to reduce wiring delay and wiring complexity;
datapath directionality constraint:

$$λ {\sum }_{{e}_{D} {▯ε}_{D}} ( cos {θ}_{{e}_{D p}} - cos {θ}_{{e}_{D s}} )$$

this term is measured by the difference in the direction cosine value, with an optimization goal being to maintain the directionality of the datapath and avoid path detours; the weight parameter λ is used to adjust the intensity of the directionality optimization; cascade constraint:

$$η {\sum }_{( {c}_{p} , {c}_{s} ) ▯ C} {\sum }_{j = 1}^{M - 1} {( {x}_{{c}_{p} , j} - {x}_{{c}_{s} , j + 1} )}^{2} ,$$

where C is a set of all cascade pairs, x_{cp,j} represents a binary decision variable of predecessor node cₚ at DSP position j, and x_{cs,j+1} represents a binary decision variable of successor node cₛ at DSP position j+1;
this term ensures the close arrangement of cascaded DSP nodes in physical positions, and the weight parameter η controls the priority of cascade constraints in the overall optimization;
S205. solving the built mathematical model of the optimization problem.

Step S205 includes:
B1. improving and transforming the optimization problem into solving a min-cost flow (MCF) model.

MCF model is a classic network optimization problem, which is very suitable for dealing with resource allocation problems. The core ideas of the MCF model are as follows:

1. Network modeling: datapath DSP nodes and FPGA resources are molded as nodes of a directed graph, with DSP nodes regarded as “sources” and available positions in the FPGA regarded as “sinks”. The weight of each edge represents a “cost” required to assign a DSP node to a position, and the cost includes path length, directional deviation, and the degree of violation of cascading relationships.

2. Capacity constraints: Hard constraints are modeled by capacity constraints on edges. For example, setting the capacity of an edge to 1 means that a position can accommodate at most one datapath DSP node.

3. Solution method: Taking advantage of the monotonicity and integer solution characteristics of the MCF model, the above analytical algorithm is used to minimize the total allocation cost while meeting constraints. Compared with directly solving integer programming problems, the MCF model takes advantage of the characteristics of network optimization algorithms to quickly obtain integer solutions and significantly improves solving efficiency.

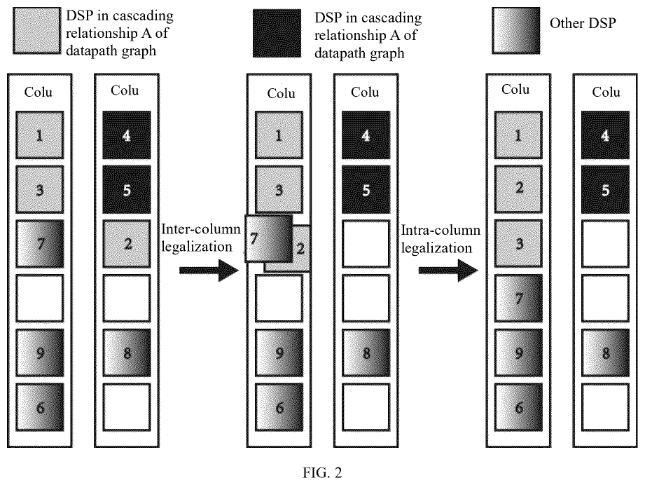

B2. after the completion of the step of datapath DSP placement optimization, in order to reduce the complexity of the algorithm, placing cascade constraints in the objective function for computation as soft constraints; because there will be a few conflicts that violate DSP cascade constraints or exceed resource constraints after the constraints are converted into soft constraints, as shown in FIG. 2, adding a step of legalization as a post-processing: to ensure that the final result meets all design rules.

Inter-column legalization is carried out, the horizontal positions of the datapath DSP are adjusted to ensure that the path DSP nodes in a cascading relationship are located in the same column, while minimizing horizontal displacement; this goal is achieved by the hard constraints of integer linear programming, and the optimization problem here is formalized to the following formulas:

$${min}_{{t}_{i , k}} {\sum }_{i = 1}^{N} {\sum }_{k = 1}^{Ncol} {D}_{col} ( i , k ) {t}_{i , k} , \qquad ( 2 )$$

$$s . t . {\sum }_{k = 1}^{Ncol} {t}_{i , k} = 1 , ∀ i ∈ \{ 1 , 2 , … , N \} , \qquad ( 2 a )$$

$${\sum }_{i = 1}^{N} {t}_{i , k} \leq {M}_{K} , ∀ k ∈ \{ 1 , 2 , … , Ncol \} , \qquad ( 2 b )$$

$${t}_{{c}_{p} , k} = {t}_{{c}_{s} , k} , ∀ ( {c}_{p} , {c}_{s} ) ∈ C , \qquad ( 2 c )$$

$${t}_{i , k} ∈ \{ 0 , 1 \} , ∀ i ∈ \{ 1 , 2 , … , N \} , ∀ k ∈ \{ 1 , 2 , … , Ncol \} ;$$

t_{i,k} is a binary variable that indicates whether path DSP node i is assigned to column k: if yes, t_{i,k} is 1, if not, t_{i,k} is 0; D_{col}(i,k) is a horizontal displacement of path DSP node i from the current column to column k, Ncol represents the number of path DSP node columns on the FPGA, Mk represents the number of available DSP positions for column k; C represents the set of all cascade pairs, cₚ and cₛ are front and back nodes cascaded, i.e., predecessor and successor nodes; t_{c}_{ₚ}_{,k} and t_{c}_{ₛ}_{,k} represent binary variables of the predecessor and successor nodes;
the objective function (2) minimizes the weighted sum of the horizontal displacements of all path DSP nodes, and the constraint (2a) ensures that each path DSP node is assigned to and only assigned to one column; the constraint (2b) ensures that the number of path DSP nodes per column does not exceed the number of available positions; the constraint (2c) ensures that path DSP nodes in a cascading relationship must be assigned to the same column; by solving this optimization problem, the horizontal positions of the datapath DSP nodes can be effectively adjusted;
Intra-column legalization:

After obtaining the solution for inter-column legalization, intra-column legalization further optimizes the vertical position of DSP nodes in each column, ensuring that the DSP nodes in a cascading relationship are closely arranged, while allowing gaps between non-cascaded nodes. The optimization problem here is formalized into the following formulas:

$${min}_{r , i} {\sum }_{i = 1}^{{N}_{k}} \vert {r}_{i} - Rcol ( i ) \vert , \qquad ( 3 )$$

$$s . t . {r}_{i} ∈ \{ 1 , 2 , … , {M}_{k} \} , ∀ i ∈ \{ 1 , 2 , … , {N}_{k} \} ,$$

$${r}_{i + 1} - r = 1 , ∀ ( i , i + 1 ) ∈ {C}_{k} , \qquad ( 3 a )$$

$${r}_{i + 1} - r \geq 1 , ∀ ( i , i + 1 ) ∉ {C}_{k} , \qquad ( 3 b )$$

rᵢ represents the vertical position of path DSP node i; R_{col}(i) is the vertical position of path DSP node i in the initial placement, Mₖ is the total number of DSP positions in column k, Nₖ is the number of DSP nodes in column k, and Cₖ represents the set of all cascading relationships in column k;
the objective function (3) minimizes the deviation between the current vertical position of the DSP node and the initial position of the DSP node; constraint (3a) ensures that the DSP nodes in a cascading relationship are closely arranged; constraint (3b) allows gaps between non-cascaded nodes to avoid overlap. By solving this optimization problem, the impact of vertical displacement on placement compactness is minimized while maintaining cascade constraints.

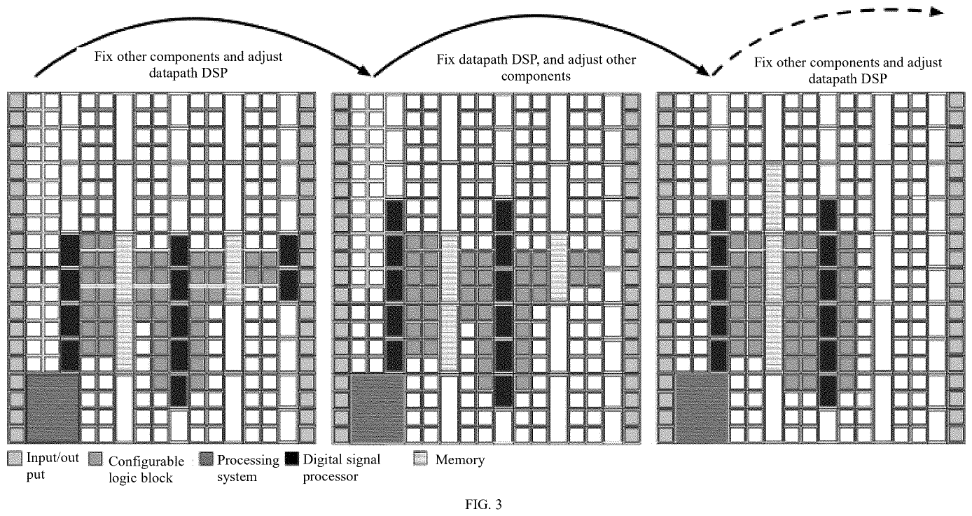

As shown in FIG. 3, in order to further improve the compactness of the placement and meet cascade constraints, the present invention adopts an incremental iterative optimization method: first, the initial positions of all logic components of the design netlist are given (the initial positions may be generated using an existing FPGA placement tool, such as vivado or AMF2.0); after the identification of the datapath DSP nodes and the building of the datapath DSP graph are completed according to step S1, the positions of other components except the path DSP nodes are fixed, and only the placement of the datapath DSP nodes is optimize according to step S2 to generate a preliminary result;
then, the positions of the datapath DSP nodes are fixed, and then the positions of other components except the path DSP nodes are adjusted using a commercial (or open-source) placement tool (such as vivado or AMF2.0, one of their rules is to minimize the distance between connected components, thereby reducing the wire length and realizing fast data communication);
in subsequent iterations, the positions of datapath DSP nodes and other components are fixed alternately for iterations to continuously optimize the overall placement;
convergence determination: when the variation of the objective function of Formula (1) is less than a preset threshold, the iteration is stopped and a final result is output.

The DSP placement optimization framework of the present invention was evaluated in multiple experimental environments. The experimental settings included a target device, benchmark designs, GCN training and placement configuration, and the optimization effect of the framework was verified by comparative analysis. In this experiment, XilinxZynqUltraScale+MPSoCZCU104 FPGA was selected as a target device. The device had column-distributed heterogeneous resources (such as LUTs, DSPs, and RAMs), which could fully verify the effectiveness of the present invention in complex designs. The benchmark designs used multiple test cases from DAC system design competitions, including iSmartDNN, SkyNet, and the expanded SkrSkr series designs. The number of DSP nodes covers the range of 197 to 1431, covering CNN accelerators of different sizes. The experimental environment ran on a Linux workstation equipped with a 10-core CPU, and combined tools such as Vivado2020.2 and RapidWright for synthesis and displacement routing.

In the stage of datapath DSP extraction, a graph neural network (GCN)-based DSP node classification method was used in the present invention. By extracting features such as proximity centrality, betweenness centrality, in-degree, out-degree and averaged shortest path length from the design netlist, the global and local attributes of DSP nodes were comprehensively reflected. The GCN model with a two-layer convolution structure combined a three-layer fully connected layer and a Softmax classifier for classification, and a weighted loss function was used to deal with category imbalance problems. Cross-verification results show that the classification accuracy rate of the GCN reaches 96% on average, which is significantly better than that of the traditional support vector machine (SVM), which is 81%, fully proving the accuracy of datapath information extraction.

In the placement optimization stage, the initial placement was generated using Vivado, at firstly and the clock frequency was gradually increased to test the performance limit of the tool. Subsequently, the DSP placement optimization framework of the present invention was used for optimization based on the MCF model, where the maximum iteration number was set to 50, and the weight parameter λ for the datapath constraint was set to 100. After the placement was completed, the placement was further adjusted by means of inter-column and intra-column legalization to strictly meet cascade constraints and minimize displacement deviations. The optimization results show that the framework of the present invention shows excellent performance in multiple benchmark designs. The present invention improves the worst negative slack (WNS) by an average of 32% as compared to Vivado and by 65% as compared to AMF-Placer. In addition, although a compact placement may slightly increase wire length, the impact is minimal and the placement still remains efficient and controllable. In terms of runtime, compared with AMF-Placer, DSPlacer's time is reduced by approximately 50%, demonstrating excellent efficiency.

Analysis of the placement results shows that the present invention is particularly outstanding in two aspects. Firstly, the datapath-driven compact placement effectively reduces wiring detours; secondly, the cascade constraints are strictly adhered to to improve the timing consistency of the placement. The visualization of the placement further verifies these advantages. Compared to Vivado and AMF-Placer, DSPlacer generates a placement with more regular and compact datapaths, significantly reducing the number of cross-column connections.

The following table compares the present invention with two mainstream placement tools (AMD Xilinx Vivado 2020.2, AMF-Placer 2.0) in terms of slack performance, wiring length, and runtime. This table shows the running result obtained by slowly increasing the running frequency of the present invention until a timing violation occurs, and then applying this frequency to other tools. The present invention is named “DSPlacer” in the table.

TABLE II
Experiment Result.

| | Vivado | | | | AMF | | |
|---|---|---|---|---|---|---|---|
| | WNS | TNS | HPWL | Runtime | WNS | TNS | HPWL |
| Benchmark | (ns) | (ns) | (um) | (s) | (ns) | (ns) | (um) |
| iSmartDNN | −0.131 | −0.391 | 2965232 | 771 | −0.830 | −649.995 | 5152227 |
| SkyNet | −0.164 | −7.765 | 3482155 | 868 | −0.154 | −3.557 | 3633692 |
| SkrSkr-1 | −0.587 | −97.799 | 2488788 | 775 | −0.883 | −4043.358 | 3384970 |
| SkrSkr-2 | −0.597 | −826.739 | 3700116 | 1091 | −1.865 | −16672.268 | 8809141 |
| SkrSkr-3 | −0.216 | −21.417 | 4034489 | 1232 | −0.786 | −804.950 | 6104589 |
| Normalize | 1.325× | 1.042× | 0.550× | 0.485× | 1.658× | 1.103× | 1.446× |

| | AMF | DSPlacer | | | |
|---|---|---|---|---|---|
| | Runtime | | | HPWL | Runtime |
| Benchmark | (s) | WNS | TNS | (um) | (s) |
| iSmartDNN | 1552 | 0.151 | 0 | 3107487 | 865 |
| SkyNet | 970 | 0.189 | 0 | 3878462 | 940 |
| SkrSkr-1 | 691 | −0.164 | −109.042 | 4473110 | 701 |
| SkrSkr-2 | 4486 | 0.009 | 0 | 4489697 | 2462 |
| SkrSkr-3 | 3329 | 0.007 | 0 | 4912782 | 1755 |
| Normalize | 2.145× | 1.000× | 1.000× | 1.000× | 1.000× |

### Description of Key Indicators:

### 1. Worst Negative Slack (WNS):

The closer the WNS is to 0 or a positive value, the easier it is for the design to meet the clock frequency requirements. Compared with other tools, the present invention is better than existing commercial and open source tools on different design benchmarks in terms of WNS. Compared with Vivado, DSPlacer improved WNS by an average of 32.5%; compared with AMF-Placer, DSPlacer improved WNS by an average of 65%, with the most significant improvement on SkrSkr-2 (from −1.865 ns to 0.009 ns).

### 2. Total Negative Slack (TNS):

The sum of the negative slacks for all paths that violate timing constraints, TNS=0 means that there are no timing violations. DSPlacer realized TNS=0 on iSmartDNN, SkyNet, SkrSkr-2 and SkrSkr-3, which fully meets timing constraints; as a contrast, Vivado (such as −826.739 ns on SkrSkr-2) and AMF-Placer (such as −16672.268 ns on SkrSkr-2) had a large number of timing violations.

### 3. Half-Perimeter Wire Length (HPWL)

As a measure of wiring complexity, the smaller the HPWL, the lower the wiring delay and power consumption. Although the HPWL of DSPlacer was slightly higher than that of Vivado (e.g., increase from 2965232 μm to 3107487 μm on iSmartDNN), but much lower than that of AMF-Placer (e.g., decrease from 8809141 μm to 4489697 μm on SkrSkr-2). This is because DSPlacer prioritizes timing performance, reduces critical path delay by means of a compact DSP placement, and a small increase in HPWL is acceptable.

### 4. Rutime

The runtime of the present invention is between those of Vivado and AMF-Placer, with an average of 1.1 times that of Vivado and 0.47 times that of AMF-Placer. Because the present invention has extra datapath extraction time and datapath placement time, extra runtime is normal. The reason why the present invention is faster than AMF is because we also account for the time it takes to import placement results into Vivado using TCL language commands in the AMF process, and it generally takes more time.

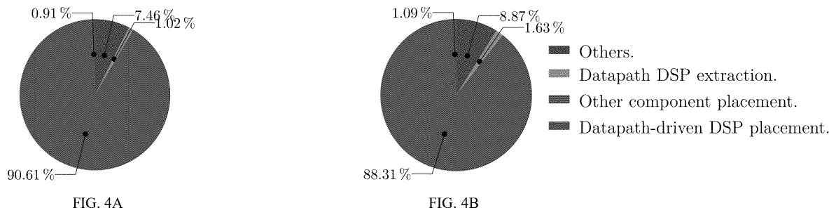

Referring to FIGS. 4A and 4B, pie charts for runtime analysis of the present invention are provided. FIGS. 4A and 4B show the runtime distribution of the present invention on the two designs of iSmartDNN and SkyNet, and clarify the time proportion of each module.

It can be learnt from the figures that the core modules (datapath DSP extraction and datapath-driven DSP placement) of the present invention only account for 2%-2.6% of the total time, indicating that the core algorithm of the present invention is highly efficient. In the figures, “others” mostly refers to the import and export of files, and “other component placement” refers to the placement of other components by other tools.

To sum up, the DSP placement optimization framework of the present invention is superior to existing tools in terms of timing performance, placement compactness and operation efficiency by integrating datapath information and efficient optimization algorithms, and provides a universal and efficient solution for CNN accelerator design on FPGAs.

The foregoing is the preferred embodiments of the invention, and it should be appreciated that the invention is not limited to the form disclosed herein and these preferred embodiments should not be construed as an exclusion of other embodiments, but may be used in other combinations, modifications and environments, and can be modified within the scope of the concepts described herein, based on the above teachings or by technology or knowledge of the relevant fields. Modifications and changes made by those in the art do not depart from the spirit and scope of the invention, but should be within the scope of the appended claims.

What is claimed is:

1. An field programmable gate array (FPGA)-oriented digital signal processing unit (DSP) placement optimization method for convolutional neural network (CNN) accelerators, comprising the following steps:
S1: DSP path information extraction: converting a design netlist into a graph representation, and carrying out datapath DSP node identification and datapath DSP graph building; and
S2: datapath-driven DSP placement: allocating datapath DSP nodes to specific positions on an FPGA according to an extracted datapath DSP graph; wherein
step S2 comprises:
S201: transforming a datapath DSP node placement problem into a constrained optimization problem and modeling the datapath DSP placement problem:
setting that the datapath DSP graph comprises N datapath DSP nodes to be placed, mapping each datapath DSP node vᵢ, i∈{1,2 . . . ,N}, to one of M DSP positions in the FPGA;
setting the coordinates of DSP position j as (p_{x,j},p_{y,j}), j∈{1,2 . . . ,M};
introducing a binary decision variable xi, where j represents an allocation relationship:
$${x}_{i , j} = \{ \begin{matrix}1 , if datapath DSP node i is assigned to DSP position j \\ 0 , datapath DSP node i is not assigned to DSP position j\end{matrix}$$
giving basic hard constraints that must be met by a datapath DSP node placement:
single position constraint: each datapath DSP node must be assigned to one position;
position uniqueness constraint: each position can only be allocated with at most one datapath DSP node;
S202: introducing cascade constraints for the datapath DSP nodes so that the datapath DSP nodes can be arranged in cascade form in the placement, in order to maintain compactness and directionality of a data link:
wherein datapath DSP nodes cascaded on the DSP graph must be arranged in adjacent positions in the same column;
a cascading relationship between multiple datapath DSP nodes is decomposed into cascading relationships between multiple DSP pairs; the cascading relationship between DSP nodes in each pair is a cascade pair; let C be a set of all cascade pairs, each cascade pair in the set C is denoted as (cₚ, cₛ), cₚ and cₛ represent predecessor and successor nodes respectively, the following constraint needs to be satisfied: cₚ and cₛ are adjacent in placement to ensure continuity and efficiency of signaling; that is, the following constraint needs to be satisfied:
$${x}_{cp , j} = {x}_{cs , j + 1} , ∀ ( {c}_{p} , {c}_{s} ) ∈ C$$
where x_{cp,j} represents a binary decision variable of predecessor cp at DSP position j, and x_{cs, j+1} represents a binary decision variable of successor cₛ at DSP position j+1;
S203: incorporating a cascade constraint and a datapath constraint into an overall optimization goal and transforming the constraints into soft constraints so as to build a model in a unified manner because in DSP placement, the cascade constraint needs to be met, and further optimization is also required for the characteristics of datapaths to improve placement compactness and timing performance:
wherein an overall mathematical model combines the directionality and placement compactness of datapaths and is expressed as follows:
$${min}_{{x}_{i , j}} {\sum }_{e □ε} {( {x}_{{e}_{p}} - {x}_{{e}_{s}} )}^{T} ( {p}_{x} {p}_{x}^{T} + {p}_{y} {p}_{y}^{T} ) ( {x}_{{e}_{p}} - {x}_{{e}_{s}} ) + λ {\sum }_{{e}_{D} □ {ε}_{D}} ( cos {θ}_{{e}_{D p}} - cos {θ}_{{e}_{D s}} ) + η {\sum }_{( {c}_{p} , {c}_{s} ) □ C} {\sum }_{j = 1}^{M - 1} {( {x}_{{c}_{p} , j} - {x}_{{c}_{s} , j + 1} )}^{2} , \\ s . t . {\sum }_{j = 1}^{M} {x}_{i , j} = 1 , {\sum }_{i = 1}^{N} {x}_{i , j} \leq 1 , {x}_{i , j} ∈ \{ 0 , 1 \} ; \qquad ( 1 )$$
where ε represents an edge set of any datapath DSP nodes and other component nodes respectively connected to the datapath DSP nodes in a directed graph after netlist conversion, e is an edge in ε, and ε_{D} represents an edge set in the datapath DSP graph, and e_{D} is an edge in ε_{D}; eₚ and eₛ represent the predecessor node and successor node of edge e respectively, xₑ_{ₚ} and xₑ_{ₛ} represent assignment variables of the predecessor node and successor node respectively and are both vectors of length S; S represents the number of placement positions of all components on the FPGA; if eₚ is assigned to position p, then in xₑ_{ₚ}, element p is 1 and the remaining elements are 0; if eₛ is assigned to position q, then in xₑ_{ₛ} the element p is 1 and the remaining elements are 0, where p=1, 2, . . . , S; q=1, 2, . . . , S, and p is not equal to q;
pₓ is a vector composed of the x coordinates of the placement positions of all components on the FPGA; p_{y} is a vector composed of the y coordinates of the placement positions of all components on the FPGA; since the number of placement positions is S, the lengths of pₓ and p_{y} are both S; the superscript T represents transposition, and
$$( {p}_{x} {p}_{x}^{T} + {p}_{y} {p}_{y}^{T} )$$
constitutes a distance matrix;
xₑ_{ₚ}-xₑ_{ₛ} represents a difference vector between vectors xₑ_{ₚ} and xₑ_{ₛ}; in the difference vector, one element is 1, one element is −1, and other elements are 0; the positions of element “1” and element “−1” represent the positions of the predecessor and successor nodes;
θₑ_{_{Dp}} represents an angle between a line from the predecessor node e_{Dp} of edge e_{D} to an ARM core in the FPGA and a horizontal line; θₑ_{_{Ds}} represents an angle between a line from the successor node e_{Ds} of edge e_{D} to the ARM core in the FPGA and the horizontal line; wherein the ARM core is located in the lower left corner of the FPGA by default; λ is a super parameter, and η is a penalty factor;
hard constraints directly limit the legitimacy of placement variable x_{i,j} to ensure that the resource allocation of DSP nodes on the FPGA meets basic rules:
single position constraint: each datapath DSP node i must and can only be assigned to one position j, that is:
$${\sum }_{j = 1}^{M} {x}_{i , j} = 1 , ∀ i ∈ \{ 1 , 2 , … , N \}$$
this constraint ensures that each datapath DSP node does not occupy multiple positions repeatedly;
resource restriction constraint: each position j can only accommodate at most one datapath DSP node; the resource restriction constraint is expressed as:
$${\sum }_{i = 1}^{N} {x}_{i , j} \leq 1 , ∀ j ∈ \{ 1 , 2 , … , M \}$$
this constraint ensures reasonable use of limited resources on the FPGA and avoids resource conflicts;
variable legitimacy constraint: x_{i,j} is a binary variable, indicating whether a datapath DSP node i is assigned to a position j; that is:
$${x}_{i , j} ∈ \{ 0 , 1 \} , ∀ i ∈ \{ 1 , 2 , … , N \} , ∀ j ∈ \{ 1 , 2 , … , M \}$$
S204: three penalty terms in an objective function together constituting soft constraints, wherein these constraints achieve flexible placement adjustments based on weight parameters of the optimization process:
distance constraint for a datapath DSP node and other components connected to the node:
$${\sum }_{e □ε} {( {x}_{{e}_{p}} - {x}_{{e}_{s}} )}^{T} ( {p}_{x} {p}_{x}^{T} + {p}_{y} {p}_{y}^{T} ) ( {x}_{{e}_{p}} - {x}_{{e}_{s}} )$$
this term represents the sum of the squares of distances between a DSP node in a path and other component nodes connected to the node, with an optimization goal being to minimize the length of the datapath to reduce wiring delay and wiring complexity;
datapath directionality constraint:
$$λ {\sum }_{{e}_{D} □ {ε}_{D}} ( cos {θ}_{{e}_{D p}} - cos {θ}_{{e}_{D s}} )$$
this term is measured by the difference in direction cosine value, with an optimization goal being to maintain the directionality of the datapath and avoid path detours; λ is used to adjust the intensity of the directionality optimization;
cascade constraint:
$$η {\sum }_{( {c}_{p} , {c}_{s} ) □ C} {\sum }_{j = 1}^{M - 1} {( {x}_{{c}_{p} , j} - {x}_{{c}_{s} , j + 1} )}^{2} ,$$
where C is a set of all cascade pairs, x_{cp,j} represents a binary decision variable of predecessor node cₚ at DSP position j, and x_{cs, j+1} represents a binary decision variable of successor node cₛ at DSP position j+1;
this term ensures the close arrangement of cascaded DSP nodes in physical positions, and the weight parameter η controls the priority of cascade constraints in the overall optimization; and
S205: solving the built mathematical model of the optimization problem.

2. The FPGA-oriented DSP placement optimization method for CNN accelerators according to claim 1, wherein step S1 comprises:
S101: graph representation and datapath DSP node identification: converting the design netlist into a directed graph, and classifying datapath DSP nodes and control-path DSP nodes, thereby realizing datapath DSP node identification; and
S102: after completing the DSP classification, only retaining the identified datapath DSP nodes, and building a datapath DSP graph based on the identified datapath DSP nodes.

3. The FPGA-oriented DSP placement optimization method for CNN accelerators according to claim 2, wherein step S101 comprises:
A1: giving a design netlist which comprises logic components and connection relationships between the logic components;
A2: converting the design netlist into a directed graph G=(V, E), wherein nodes in a node set V of the directed graph represent the logic components in the design netlist, and edges in an edge set E represent connection relationships between the logic components;
A3: extracting features of each node from the design netlist, including local features and global features, wherein the local features comprise an in-degree and an out-degree and the global features comprise proximity centrality, betweenness centrality, eccentricity, and the number of feedback loops;
for any node v in the node set V, the in-degree, out-degree, between-centrality, near-centrality, eccentricity, and number of feedback loops are defined as follows:
the in-degree of node v refers to the number of nodes connected to an input terminal of node v;
the out-degree of node v refers to the number of nodes connected to an output terminal of node v;
betweenness centrality measures the importance of a node as an intermediary for the shortest path between other nodes, and the betweenness centrality of node v is defined as follows:
$${C}_{B} ( v ) = {\sum }_{{u}_{i} , {u}_{l} □ V} \frac{σ ( {u}_{i} , {u}_{l} ) \vert v}{σ ( {u}_{i} , {u}_{l} )}$$
where σ(uᵢ,uₗ) represents the number of shortest paths between nodes uᵢ and uₗ, σ(uᵢ,uₗ)/vrepresents the number of paths passing through node v among these paths, and C_{B}(v) represents the betweenness centrality of node v;
proximity centrality is used to measure the reciprocal of an averaged distance between a node and other nodes, and the proximity centrality of node v is defined as follows:
$${C}_{C} ( v ) = \frac{1}{{\sum }_{u □ V , u \neq u} d ( v , u )}$$
where d (v, u) represents a shortest path distance between node v and node u, and C_{C}(v) represents the proximity of node v;
eccentricity measures a distance between a node and the other node farthest away, and the eccentricity of node v is defined as follows:
$$ecc ( v ) = {}_{u ∈ V}^{max} d ( v , u )$$
where d (v, u) represents a shortest path distance between node v and node u, and ecc(v) represents the eccentricity of node v;
the number of feedback loops at node v refers to the number of paths starting from node v and returning to node v;
A4: modeling a DSP identification problem as a binary classification problem, and labeling some DSP nodes in the node set V: labeling the datapath DSP nodes as one category, and labeling the control-path DSP nodes as another category;
A5: building a graph neural network model, the graph neural network model comprising: a graph convolutional neural network (GCN), a ReLU activation function, a dropout layer, a graph convolutional neural network (GCN), a ReLU activation function, a dropout layer, a fully connected layer and a Softmax classifier, which are connected in sequence; and
A6: training the graph neural network model using the features of the labeled nodes, and classifying unlabeled DSP nodes in the node set V by the trained and mature graph neural network model, thereby realizing datapath DSP node identification.

4. The FPGA-oriented DSP placement optimization method for CNN accelerators according to claim 3, wherein the logic components comprise DSPs, lookup tables (LUTs) and random access memories (RAMs).

5. The FPGA-oriented DSP placement optimization method for CNN accelerators according to claim 3, wherein step S102 comprises:
shortest path calculation: starting from each datapath DSP node, calculating the shortest path to other datapath DSP nodes using an iterative deepening depth-first search algorithm; and
based on the shortest path information, building a subgraph that only contains the datapath DSP nodes and connection relationships thereof, wherein the graph describes the topology between the datapath DSP nodes and is denoted as datapath DSP graph, and connection relations of the datapath DSP nodes are edges of the datapath DSP graph.

6. The FPGA-oriented DSP placement optimization method for CNN accelerators according to claim 1, wherein step S205 comprises:
B1: improving and transforming a nonlinear problem into a linear problem by means of linearization technology because the objective function and constraints of the optimization problem comprise nonlinear terms; and after the linearization is completed, further improving and transforming the optimization problem into solving a min-cost flow (MCF) model:
network modeling: molding datapath DSP nodes and FPGA resources as nodes of the directed graph, with FPGA resources regarded as available positions in the FPGA, wherein path DSP nodes are regarded as sources, and the available positions in the FPGA are regarded as sinks;
the weight of each edge represents a “cost” required to assign a path DSP node to a corresponding position, and the cost comprises path length, directional deviation, and the degree of violation of cascading relationships;
capacity constraints: modeling the hard constraints by means of edge capacity constraints to minimize the total allocation cost when the constraints are met;
solving the minimum cost flow model to obtain the placement positions of datapath DSP nodes;
B2: after the completion of the step of datapath DSP placement optimization, in order to reduce the complexity of the algorithm, placing the cascade constraint in the objective function for computation as a soft constraint; because there are a few violations of the DSP cascade constraint or conflicts that exceed resource constraints after the constraint is converted into the soft constraint, adding a step of legalization as a post-processing:
carrying out inter-column legalization, and adjusting the horizontal positions of the datapath DSP nodes to ensure that the path DSP nodes in a cascading relationship are located in the same column, while reducing horizontal displacement, wherein this goal is achieved by the hard constraints of integer linear programming, and the optimization problem here is formalized into the following formulas:
$${min}_{{t}_{i , k}} {\sum }_{i = 1}^{N} {\sum }_{k = 1}^{Ncol} {D}_{col} ( i , k ) {t}_{i , k} , \qquad ( 2 )$$
$$s . t . {{\sum }_{k = 1}}^{Ncol} {t}_{i , k} = 1 , ∀ i ∈ \{ 1 , 2 , … , N \} , \qquad ( 2 a )$$
$${\sum }_{i = 1}^{N} {t}_{i , k} \leq {M}_{K} , ∀ k ∈ \{ 1 , 2 , … , Ncol \} , \qquad ( 2 b )$$
$${t}_{{c}_{p} , k} = {t}_{{c}_{s} , k} , ∀ ( {c}_{p} , {c}_{s} ) ∈ C , \qquad ( 2 c )$$
$${t}_{i , k} ∈ \{ 0 , 1 \} , ∀ i ∈ \{ 1 , 2 , … , N \} , ∀ k ∈ \{ 1 , 2 , … , Ncol \} ;$$
where t_{i,k} is a binary variable that indicates whether path DSP node i is assigned to column k: if yes, t_{i,k} is 1, if not, t_{i,k} is 0; D_{col} (i, k) is a horizontal displacement of path DSP node i from the current column to column k, Ncol represents the number of path DSP node columns on the FPGA, Mₖ represents the number of available DSP positions for column k; C represents the set of all cascade pairs, cₚ and cₛ are front and back nodes cascaded, i.e., predecessor and successor nodes; t_{c}_{ₚ}_{,k} and t_{c}_{ₛ}_{,k} represent binary variables of the predecessor and successor nodes;
the objective function (2) minimizes the weighted sum of the horizontal displacements of all path DSP nodes, and the constraint (2a) ensures that each path DSP node is assigned to and only assigned to one column; the constraint (2b) ensures that the number of path DSP nodes per column does not exceed the number of available positions; the constraint (2c) ensures that path DSP nodes in a cascading relationship must be assigned to the same column; by solving this optimization problem, the horizontal positions of the datapath DSP nodes can be effectively adjusted;
intra-column legalization:
after obtaining the solution for inter-column legalization, carrying out intra-column legalization to further optimize vertical positions of DSP nodes in each column, ensuring that the DSP nodes in a cascading relationship are closely arranged, while allowing gaps between non-cascaded nodes, wherein the optimization problem here is formalized into the following formulas:
$${min}_{{r}_{i}} {\sum }_{i = 1}^{{N}_{k}} \vert {r}_{i} - R c o l ( i ) \vert , \\ s . t . {r}_{i} ∈ \{ 1 , 2 , … , {M}_{k} \} , ∀ i ∈ \{ 1 , 2 , … , {N}_{k} \} , \qquad ( 3 )$$
$${r}_{i + 1} - r = 1 , ∀ ( i , i + 1 ) ∈ {C}_{k} , \qquad ( 3 a )$$
$${r}_{i + 1} - r \geq 1 , ∀ ( i , i + 1 ) ∉ {C}_{k} , \qquad ( 3 b )$$
rᵢ represents the vertical position of path DSP node i; Rcol(i) is the vertical position of path DSP node i in the initial placement, Mₖ is the total number of DSP positions in column k, Nₖ is the number of DSP nodes in column k, and Cₖ represents the set of all cascading relationships in column k;
the objective function (3) minimizes the deviation between the current vertical position of the DSP node and the initial position of the DSP node; constraint (3a) ensures that the DSP nodes in a cascading relationship are closely arranged; constraint (3b) allows gaps between non-cascaded nodes to avoid overlap; by solving this optimization problem, the impact of vertical displacement on placement compactness is minimized while maintaining cascade constraints.

7. The FPGA-oriented DSP placement optimization method for CNN accelerators according to claim 1, further comprising:
first, giving initial positions of all logic components of the design netlist; after the identification of the datapath DSP nodes and the building of the datapath DSP graph are completed according to step S1, fixing the positions of other components except the path DSP nodes, and only optimizing the placement of the datapath DSP nodes according to step S2 to generate a preliminary result;
then, fixing the positions of the datapath DSP nodes, and then adjusting the positions of other components except the path DSP nodes using a commercial placement tool;
in subsequent iterations, fixing the positions of the datapath DSP nodes and other components alternately for iterations to continuously optimize the overall placement; and
convergence determination: when the variation of the objective function of Formula (1) is less than a preset threshold, stopping the iteration and outputting a final result.
